(19) United States
(12) Patent Application Publication
(10) Pub. No.: US 2024/0070489 A1
(43) Pub. Date: Feb. 29, 2024

(54) PERSONALIZED QUESTION ANSWERING USING SEMANTIC CACHING

(71) Applicant: WORKDAY, INC., Pleasanton, CA (US)

(72) Inventors: Christopher DANG, Pleasanton, CA (US); Zach ZHANG, San Francisco, CA (US); Milan DESAI, Pleasanton, CA (US); Himanshu ARORA, TORONTO (CA); Pengcheng JIA, TORONTO (CA); Krutika INGALE, Pleasanton, CA (US)

(21) Appl. No.: 17/821,640

(22) Filed: Aug. 23, 2022

(51) Int. Cl. G06N 5/04; G06F 16/33; G06N 5/02

(52) U.S. Cl. CPC G06N 5/04; G06F 16/3334; G06N 5/022

(57) ABSTRACT

The disclosure relates to an offline-online question answering system. In some aspects, the techniques described herein relate to a method including: receiving, by a processor, a query from a user; generating, by the processor, a query embedding representing the query; identifying, by the processor, at least one question corresponding to the query by comparing the query embedding to a plurality of embeddings of questions; and transmitting, by the processor, an answer corresponding to the at least one question to the user in response to the query.

### BACKGROUND

Inter-document search, such as open-domain question answering, is becoming increasingly important for systems storing text documents. This technology can be applied to various types of text content, including knowledge articles, learning transcripts, supplier contracts, etc.

However, real or near real-time open-domain question answering is currently computationally prohibitive as it requires searching through multiple long-form documents to identify an answer. Achieving a high level of accuracy necessitates the use of large language models that require specialized hardware (such as graphics processing units) that are not often accessible within data centers where requests are served. As an alternative, some current systems use a precomputed question to answer extraction, which avoids excessive compute times but significantly limits the number of answerable queries as there are limitless variations to how a question can be asked. Further, current systems assume a single correct answer per question. This assumption frequently fails as many systems support users globally, and the correct answer may depend on the location relevant for the answer and the location of the user.

As a result, current technical approaches to inter-document search (e.g., question answering) fail to provide meaningful results within the computational constraints of most processing environments.

### BRIEF DESCRIPTION OF THE FIGURES

FIG. 1 is a block diagram illustrating a system for identifying recommended answers to user queries.

FIG. 2 is a flow diagram illustrating a method for identifying recommended answers to user queries.

FIG. 3 is a flow diagram illustrating a method for generating a question-answer mapping.

FIG. 4 is a flow diagram illustrating a method for training an answer transformer.

FIG. 5 is a block diagram of a computing device.

### DETAILED DESCRIPTION

In some aspects, the techniques described herein relate to a method including receiving, by a processor, a query from a user; generating, by the processor, a query embedding representing the query; identifying, by the processor, at least one question corresponding to the query by comparing the query embedding to a plurality of embeddings of questions; and transmitting, by the processor, the at least one question and an answer corresponding to the at least one question to the user in response to the query.

In some aspects, the techniques described herein relate to a method wherein comparing the query embedding to a plurality of embeddings of questions includes determining distances between the query embedding and each of the plurality of embeddings.

In some aspects, the techniques described herein relate to a method, further including generating a question-answer mapping and caching the question-answer mapping prior to receiving the query.

In some aspects, the techniques described herein relate to a method wherein generating a question-answer mapping includes: reading a question from a question bank; identifying a plurality of candidate documents for a given question in the question; inputting the plurality of candidate documents into a transformer model, the transformer model outputting one or more answers present in the plurality of candidate documents; selecting a subset of the one or more answers as answers to the given question; and storing the question and the subset of the one or more answers as a mapping for the question.

In some aspects, the techniques described herein relate to a method wherein identifying a plurality of candidate documents includes performing a search on a document corpus using the question.

In some aspects, the techniques described herein relate to a method wherein the transformer model outputs a location of the answer within a given candidate document.

In some aspects, the techniques described herein relate to a method, further including training the transformer model by loading a generic transformer model, annotating a knowledge base with questions and answers, and re-training the generic transformer model using the knowledge base.

In some aspects, the techniques described herein relate to a non-transitory computer-readable storage medium for tangibly storing computer program instructions capable of being executed by a computer processor, the computer program instructions defining the steps of receiving a query from a user; generating a query embedding representing the query; identifying at least one question corresponding to the query by comparing the query embedding to a plurality of embeddings of questions; and transmitting the at least one question and an answer corresponding to the at least one question to the user in response to the query.

In some aspects, the techniques described herein relate to a non-transitory computer-readable storage medium, wherein comparing the query embedding to a plurality of embeddings of questions includes determining distances between the query embedding and each of the plurality of embeddings.

In some aspects, the techniques described herein relate to a non-transitory computer-readable storage medium, further including generating a question-answer mapping and caching the question-answer mapping prior to receiving the query.

In some aspects, the techniques described herein relate to a non-transitory computer-readable storage medium, wherein generating a question-answer mapping includes: reading a question from a question bank; identifying a plurality of candidate documents for a given question in the question; inputting the plurality of candidate documents into a transformer model, the transformer model outputting one or more answers present in the plurality of candidate documents; selecting a subset of the one or more answers as answers to the given question; and storing the question and the subset of the one or more answers as a mapping for the question.

In some aspects, the techniques described herein relate to a non-transitory computer-readable storage medium, wherein identifying a plurality of candidate documents includes performing a search on a document corpus using the question.

In some aspects, the techniques described herein relate to a non-transitory computer-readable storage medium, wherein the transformer model outputs a location of the answer within a given candidate document.

In some aspects, the techniques described herein relate to a non-transitory computer-readable storage medium, further including training the transformer model by loading a generic transformer model, annotating a knowledge base with questions and answers, and re-training the generic transformer model using the knowledge base.

In some aspects, the techniques described herein relate to a device including a processor; and a storage medium for tangibly storing thereon logic for execution by the processor, the logic including instructions for receiving, by the processor, a query from a user; generating, by the processor, a query embedding representing the query; identifying, by the processor, at least one question corresponding to the query by comparing the query embedding to a plurality of embeddings of questions; and transmitting, by the processor, the at least one question and an answer corresponding to the at least one question to the user in response to the query.

In some aspects, the techniques described herein relate to a device, wherein comparing the query embedding to a plurality of embeddings of questions includes determining distances between the query embedding and each of the plurality of embeddings.

In some aspects, the techniques described herein relate to a device, the logic further including logic for generating a question-answer mapping and caching the question-answer mapping prior to receiving the query.

In some aspects, the techniques described herein relate to a device, wherein generating a question-answer mapping includes: reading a question from a question bank; identifying a plurality of candidate documents for a given question in the question; inputting the plurality of candidate documents into a transformer model, the transformer model outputting one or more answers present in the plurality of candidate documents; selecting a subset of the one or more answers as answers to the given question; and storing the question and the subset of the one or more answers as a mapping for the question.

In some aspects, the techniques described herein relate to a device, wherein identifying a plurality of candidate documents includes performing a search on a document corpus using the question.

In some aspects, the techniques described herein relate to a device, wherein the transformer model outputs a location of the answer within a given candidate document.

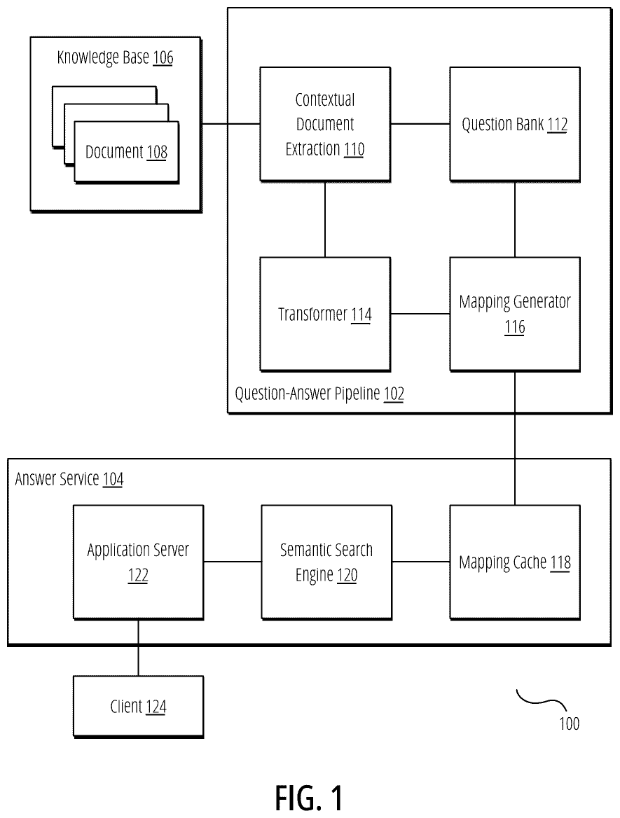

FIG. 1 is a block diagram illustrating a system for identifying recommended answers to user queries. The illustrated system 100 includes a knowledge base 106, client device 124, question-answer pipeline 102, and an answer service 104.

The knowledge base 106 can store documents 108. No limit is placed on the contents of documents 108; however, the following examples generally describe text documents (e.g., webpages, articles, etc.). In some implementations, the knowledge base 106 can be maintained independently of the question-answer pipeline 102 or answer service 104. That is, an organization may update documents 108 during normal business operations without regard to the operations of question-answer pipeline 102 and answer service 104. As one example, documents 108 may store human resources policies, internal organization handbook materials, or similar types of reference material.

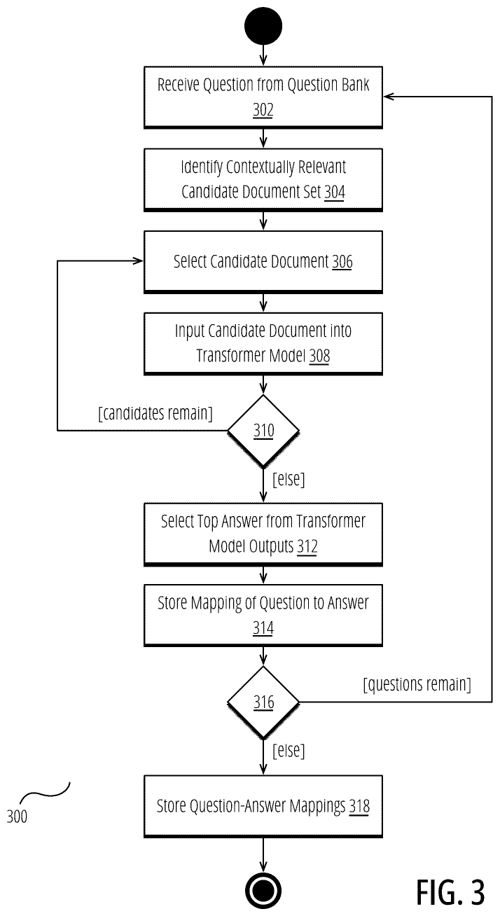

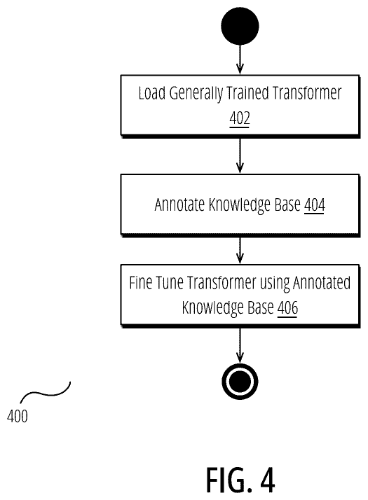

Question-answer pipeline 102 periodically accesses documents 108 and generates a mapping of questions to answers which can be persistently stored by question-answer pipeline 102 as well as transmitted to the answer service 104. Specific details of question-answer pipeline 102 are described in more detail in FIGS. 3 and 4 and are not repeated herein. In brief, question-answer pipeline 102 includes a contextual document extraction module 110 that reads questions from a question bank 112. The contextual document extraction module 110 then issues search queries to the knowledge base 106 to identify candidate documents that are relevant to the questions in the question bank 112. As discussed in FIG. 3, this search can provide a ranked list of relevant documents in the knowledge base 106.

The contextual document extraction module 110 can then input the questions and their corresponding documents into a transformer-based model 114. The transformer-based model 114 can analyze each candidate document and identify one or more likely answers to a given question in the candidate documents. Answers can be represented as a start position, end position (or length), and answer text. The transformer-based model 114 may also assign each identified answer a score which can then be used to rank the answers.

Next, a mapping generator 116 reads the question from question bank 112 and sorts the answers from transformer-based model 114. Mapping generator 116 can then select the top identified answers (e.g., based on confidence values) and associate a given question from question bank 112 with the top answers. Mapping generator 116 can then persist this mapping for each question to store a question-answer dataset. Further, the question-answer pipeline 102 can provide or transmit this question-answer dataset to the answer service 104 for local handling of queries, discussed next.

Answer service 104 can cache a question-answer dataset generated by question-answer pipeline 102 mapping cache 118. The mapping cache 118 can comprise any database or data storage device that can store data. Client device 124 can issue queries to answer service 104 via, for example, Hypertext Transfer Protocol (HTTP) messages. A query from client device 124 can include a text string representing a full question or partial question, or term. An application server 122 of answer service 104 can handle the query and extract the query for processing by a semantic search engine 120.

In some embodiments, semantic search engine 120 can convert the query into an embedding (e.g., a word or sentence embedding). Next, semantic search engine 120 can query the mapping cache 118 to identify questions that are similar to the embedding representation of the query. In some implementations, semantic search engine 120 can perform vector comparisons between an embedding representation of the query and embedding representations of each question in the mapping cache 118. In some implementations, semantic search engine 120 can further filter the world of possible questions in the mapping cache 118 based on filter criteria (e.g., the location of a user). After identifying a most similar question in the mapping cache 118, semantic search engine 120 can load the answer associated with the most similar question. Semantic search engine 120 then provides the answers back to the application server 122, which can format a response to the query (e.g., a web-based chatbot interface which displays answers).

Further details of the foregoing operations are provided in the following Figures.

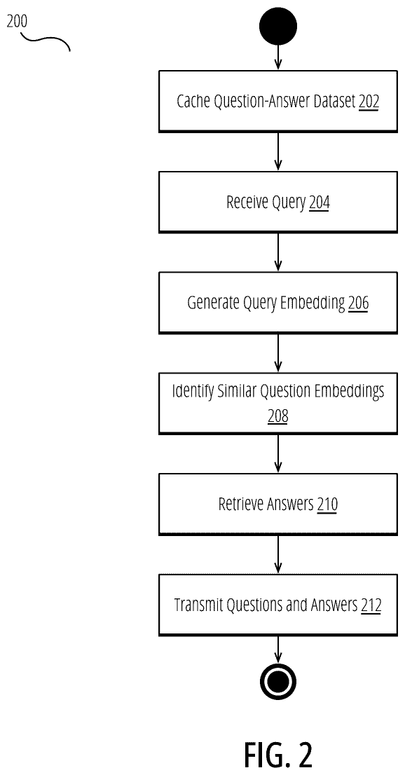

FIG. 2 is a flow diagram illustrating a method for identifying recommended answers to user queries. In some implementations, method 200 can be performed by answer service 104, although the disclosure is not limited as such.

In step 202, method 200 can include caching a question-answer dataset.

In some implementations, the question-answer dataset can include a set of questions and one or more corresponding answers. In one implementation, any given question in the set of questions can be represented as a string, while in other embodiments, the questions can be represented as embedding vectors. In some implementations, the answer can be represented as string data.

In some implementations, each question can also be associated with filter criteria. Examples of filter criteria include a locale (e.g., city, state, region, country, etc.), user type (e.g., full-time employee, contractor, etc.), or similar types of data discussed further herein.

In some implementations, the question-answer dataset may be periodically updated. For example, question-answer pipeline 102 may periodically re-generate the question-answer dataset and provide the dataset to answer service 104, which caches the question-answer dataset. Such an update can be performed on a periodic basis (e.g., monthly), and thus the question-answer dataset can be maintained and up to date.

In step 204, method 200 can include receiving a query.

A query can include a string entered by a user via, for example, a web-based or mobile interface. As one example, a website can include a chat feature that allows users to enter chat messages, and these chat messages can be used as the query. No limit is placed on the contents of the query, and the query may be a single word, a full sentence or question, or generally any other type of text enterable by the user.

In some implementations, method 200 can receive the query via network transmission. For example, a web server can expose an HTTP endpoint that allows clients to submit queries via HTTP GET or POST methods (or similar methods). As such, the queries can be included in a query string or POST body. In some implementations, the user submitting the query can be authenticated (e.g., via a password-based login scheme), and thus demographic data of the user can be retrieved along with receiving the query.

In step 206, method 200 can include generating a query embedding based on the query received in step 204.

In some implementations, method 200 can utilize a word embedding library to generate query embeddings for queries. In some implementations, method 200 can utilize an embedding model to generate a query embedding for a query embedding. The embedding model can be a word embedding model, sentence embedding model, document embedding model, or similar type of embedding model. Various types of pre-trained embedding models can be used, such as word2vec, GloVe, ELMo, BERT, or similar models. In general, any model that can convert a text string to a real-valued vector may be used.

In the implementations, the embedding model used in step 206 matches the embedding model used to generate question embeddings. As discussed in step 202, the cached question-answer dataset may include embedding representations of questions. These representations are generated using the same model used in step 206 to enable comparisons, discussed next. In some implementations, where the question-answer dataset stores string data for questions, each question can be converted to embedding representations using the same model used in step 206.

In some implementations, the entire query is used to generate a query embedding. In other implementations, a subset of the entire query may be used to generate the query embedding. For example, stopwords or similar types of words can be removed from the query before generating the query embedding. Similarly, in some implementations, the query can be parsed using a keyword extraction model to extract the most relevant words. For example, a Rapid Automatic Keyword Extraction (RAKE) model or similar model can be used to extract keywords from a query and use those keywords as input to the embedding model.

In step 208, method 200 can include identifying questions from the question-answer dataset that are similar to the query.

As discussed above, the query is converted to a query embedding, and each question in the question-answer dataset is either stored as an embedding or converted to an embedding. As such, in step 208, method 200 can compare the query embedding to each of the embeddings in the question-answer dataset to identify the query embedding (and thus question) that is most similar to the query.

In some implementations, a nearest-neighbor search algorithm can be used to quickly match the query embedding to the most similar question embedding. Examples of such an algorithm include Hierarchical Navigable Small World (HNSW), Navigating Spread-out Graph (NSG), Facebook® AI Similarity Search (FAISS), etc., although the disclosure is not limited to a specific algorithm. In general, any algorithm that can compute similarities between vectors (e.g., embeddings) can be used to compute such similarities and then rank the similarities to find the closest matching vectors.

In an optional implementation, step 208 can also include using the demographic data of the user to filter the universe of potentially matching questions. As discussed above, a user can have various items of demographic data associated with them. Further, in some implementations, each question can include its own filter criteria that corresponds to this demographic data. As one example, a user's demographic data can include a location of “New York.” A first question in the question-answer dataset can include a location filter criteria of “New York,” while a second question in the question-answer dataset can include a location filter criteria of “Pleasanton.” Thus, during step 208, method 200 can filter the question-answer database based on the demographic data of “New York” to exclude the second question from consideration. As discussed, other types of filter criteria and demographic data can be used in the alternative or in conjunction with location data. Further, filters and demographic data can be combined as necessary to improve the accuracy of searching (as well as improve performance and compute power usage due to reducing the number of comparisons).

In step 210, method 200 can include retrieving one or more answers based on the most similar question.

In some implementations, after method 200 identifies the most relevant question in the question-answer dataset, method 200 can identify the corresponding answers to the most similar question. In one implementation, method 200 can identify the most relevant answer from the corresponding answers. As will be discussed, each corresponding answer can be associated with a score, such as a confidence score. In such an implementation, method 200 can select the answer having the highest confidence score. In other implementations, however, method 200 can retrieve all answers as part of step 210. Further, in other implementations, method 200 can select a fixed number of answers. In one implementation, the answers can be ranked (e.g., via confidence scores), and a fixed number of top-scoring answers can be selected.

In some implementations, an answer can comprise a data structure that highlights text within a larger body of text. For example, each question can be associated with a text document. A given answer within that text document can be represented as a start position (e.g., integer) and a length (e.g., integer) of the answer. In other implementations, an end position can also be stored to aid in identifying the position of the answer. Such a representation can enable a client device to find and highlight (e.g., make bold) an answer within a display of the text document or a portion thereof. In some implementations, the display can link to the full-text document and only include a portion of the document near the answer (as represented by start, length, or end offsets).

In step 212, method 200 can include transmitting questions and answers to the user.

As discussed in step 204, method 200 can transmit one or more questions and one or more answers as a response to a network (e.g., HTTP) request. In response, the client device can parse and render the question(s) and answer(s) on the display of the client device.

In some implementations, a single question and one or more answers can be returned to the user. However, in other embodiments, a set of most relevant questions and corresponding answers can be returned. For example, method 200 can compute similarities between a query embedding and the question embeddings and select the top N question embeddings based on the similarity scores. Method 200 can then select the top M answers for each of the N questions. This combination of N questions and M answers per question can be returned to the user. Thus, if a user's query is “I lost my receipt,” method 200 may identify the questions “I can't find a required receipt, what are my options?” and “How do I attach a receipt to an expense report?” as the most relevant questions. As such, method 200 can identify one or more answers to these questions and provide both questions and their answers to the user.

In some implementations, method 200 can include an optional step after step 212, wherein feedback regarding the selected questions and answers can be obtained. In a first implementation, the client device can monitor user interactions with questions or answers and can record when a user interacts with questions or answers. Alternatively, or in conjunction with the foregoing, the client device can provide user interface (UI) elements (e.g., thumbs up, thumbs down) to allow a user to provide an explicitly positive or negative interaction. The client device can transmit data representing these interactions back to the server, which can then use the data to improve the mapping of queries to questions or the underlying question-answer generating model (discussed in FIG. 3).

FIG. 3 is a flow diagram illustrating a method for generating a question-answer mapping. In some implementations, method 300 can be performed by question-answer pipeline 102, although the disclosure is not limited as such. In method 300, a computing device can generate a question-answer dataset that can be cached by, for example, answer service 104 for responding to queries (discussed previously).

In step 302, method 300 can include receiving a question from a question bank.

In some implementations, the question bank can comprise a pre-defined set of well-formed questions. In some implementations, each question in the question bank is represented as a string. In some implementations, one or more human editors can generate the questions in the question bank. In some implementations, the editors can periodically review and revise questions in the question bank, including adding new or removing old questions. In some implementations, method 300

In step 304, method 300 can include identifying one or more contextually relevant documents for a given question.

In some implementations, method 300 may access a database of documents, the documents stored as part of a knowledge base of articles or other types of text documents. This database may be searchable, and in step 304, a computing device can issue a query to the database using the question received in step 302. In some implementations, the database may support full-text search functionality that utilizes a ranking function to estimate the relevance of documents in the database to a given query based on the content of the documents. An example of one type of ranking function is an Okapi BM25 ranking function. Other types of ranking functions may be used. In some implementations, the database may be separately maintained by other processes. For example, the database may store an organization's human resources policies, technology policies, or other types of information that are useable by employees of the organization. As such, the database may be updated asynchronously relative to method 300.

As a result of the query, the database returns a plurality of search results (i.e., candidate documents) that are ranked (e.g., according to a ranking function). In some implementations, method 300 can select a subset of the results (e.g., the highest ranking N results) and use this subset as the contextually relevant candidate document set in step 304.

In step 306, method 300 can select one of the candidate documents returned in step 304, and in step 308, method 300 can include inputting the selected candidate document into a transformer-based model to obtain an answer and (optional) confidence level.

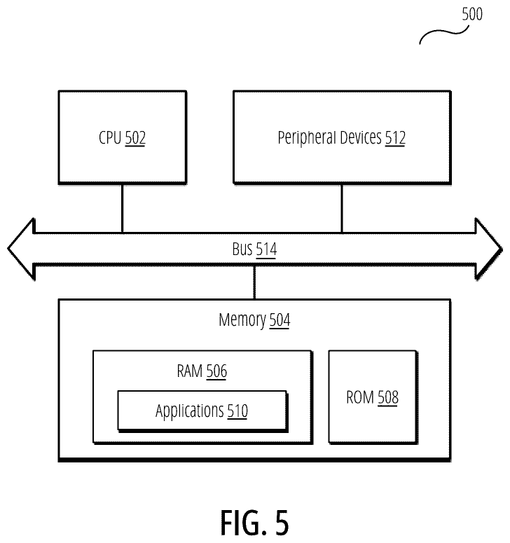

In some implementations, the transformer-based model can include a self-attention model that employs an encoder-decoder architecture. For example, the transformer-based model can include a GPT-2, GPT-3, BERT, XLNet, RoBERTa, or a similar type of model. Given an input text (e.g., document), the transformer-based model can output a position and content of a substring in the text representing an answer. Thus, as an example, if the string “All employees are entitled to 21 days of annual sick leave” is input into such a model, the model may return “21 days” and ‘30’ as the start position. Alternatively, or in conjunction with the foregoing, the model can return the length instead of the text of the answer. As discussed more fully in the description of FIG. 5, a general-purpose answer detection transformer model can be used as a base model. Such a model may be pre-trained on general corpora of text to identify answers and then fine-tuned using labeled answer data and corresponding documents from an application-specific knowledge base.

In the foregoing implementations, the question may also be included as an input to the model during step 308. Thus, continuing the previous example, the string “All employees are entitled to 21 days of annual sick leave” may represent a candidate document identified via searching in step 304, and the question “How many sick days can I take?” may be the question selected from the question bank in step 302. Both these values can be provided to the transformer model to allow the model to predict the position of a given answer within the candidate document. In some scenarios, the model may only predict a single answer; however, in other implementations, the model can predict multiple answers within a single document. In some implementations, each prediction is assigned a weight or confidence level that the prediction is accurate. As will be discussed, this confidence can be used to select a top answer using the model.

Using the foregoing steps, method 300 can select a question, and use a search engine to find the top N documents that are similar to the question based on, for example, search ranking algorithms. Then, the question and candidate documents can be fed into a question-answering transformer-based model to extract individual ranked answers to the question.

In step 310, method 300 can include determining if all candidate documents for a given question have been input into the transformer-based model. In some implementations, all candidate documents may be input and processed simultaneously by the transformer-based model, and, as such, step 310 may be optional. However, in other implementations, the transformer-based model may process documents individually, and thus step 310 ensures that all relevant candidate documents have been processed and corresponding answers have been generated.

In step 312, method 300 can include selecting the top M answers from the answers extracted by the transformer-based model. In some implementations, a single best answer can be chosen (i.e., M=1). However, in other implementations, the answers may be ranked, and the top M may be chosen, where M>1. As discussed above, in some implementations, the transformer-based model may assign a confidence value or score to the answer, and thus method 300 can sort the answers by such confidence values to obtain the top M answers having the top M confidence values. In some implementations, as discussed above, method 300 may also maintain a correspondence between the answer and the underlying document the answer was extracted from.

In step 314, method 300 can include storing a mapping of the question read in step 302 to the answer or answers selected in step 312. In some implementations, as discussed above, this mapping may be a key-value mapping wherein a question is mapped to one or more answers in a suitable data structure. In some implementations, additional metadata or links can be included in the data structure. For example, in some implementations, a link or reference to the underlying document the answer was found in may be maintained. In this manner, when displaying an answer (as described in FIG. 3), a hyperlink or other link to the referenced candidate document can be presented. As another example, filter criteria of the candidate document can be used to augment the question or answer. For example, if the answer was extracted from a document associated with a specific location this location can be used to augment either the question or the answer and then used to reduce the number of possible matches for later questions (discussed in FIG. 3).

In step 316, method 300 can include determining if any questions remain to be processed. If so, method 300 can return to step 302 for each remaining question and proceed to perform the aforementioned steps for each remaining question, generating a question-answer mapping (step 312) for each question in the question bank.

In step 318, method 300 can include storing all the question-answer mappings. As discussed in FIG. 3, method 300 can include persisting all question-answer mappings in a persistent data store. Then, method 300 can provide all question-answer mappings to an answer service 104 or similar front end for use during client queries.

FIG. 4 is a flow diagram illustrating a method for training an answer transformer.

In step 402, method 400 can include loading a generally trained transformer-based model.

As discussed in FIG. 3, the transformer-based model can include a self-attention model that employs an encoder-decoder architecture. For example, the transformer-based model can include a GPT-2, GPT-3, BERT, XLNet, RoBERTa, or a similar type of model.

In step 402, a pre-trained transformer-based model can be used as an initial model. In such an approach, the transformer-based model can be trained using a generic data set which includes questions, candidate documents, and labeled answers (e.g., start position, end position, answer text). Such a pre-trained model can be trained using a large-scale data corpus such as Wikipedia® or a similar type of general-purpose knowledge base. In general, a pre-trained general-purpose model will perform adequately for most domains; however, it will frequently fail to provide confident answers when applied to domain-specific terminology.

In step 404, method 400 can include annotating a knowledge base. In some implementations, human editors can access documents (e.g., knowledge base articles) and identify the locations of answers to questions stored in a question bank (such as the question bank discussed in FIG. 3). In some implementations, editors can manually find answers and record the start position, stop position, and answer text. Then, the question and document contents can be added to the editor-provided data to generate a training/test dataset. In some implementations, editors may provide their own questions to randomize the training data and prevent overfitting to questions in the question bank.

In step 406, method 400 can include fine-tuning the pre-trained transformer model using the dataset generated in step 404. In this step, the previously trained generic model can be re-trained using the new dataset. In this manner, the weights can be re-trained using the editor-labeled training data. However, given the previous general training, training can often be faster and result in a more accurate model.

FIG. 5 is a block diagram of a computing device.

In some embodiments, the computing device 500 can be used to perform the methods described above or implement the components depicted in the foregoing figures.

As illustrated, the computing device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a non-transitory memory system including a dynamic random-access memory (DRAM), static random-access memory (SRAM), Flash (e.g., NAND Flash), or combinations thereof. In one embodiment, bus 514 may comprise a Peripheral Component Interconnect Express (PCIe) bus. In some embodiments, bus 514 may comprise multiple busses instead of a single bus.

Memory 504 illustrates an example of non-transitory computer storage media for the storage of information such as computer-readable instructions, data structures, program modules, or other data. Memory 504 can store a basic input/output system (BIOS) in read-only memory (ROM), such as ROM 508, for controlling the low-level operation of the device. The memory can also store an operating system in random-access memory (RAM) for controlling the operation of the device

Applications 510 may include computer-readable and computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The computing device 500 may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth™, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, the claimed or covered subject matter is intended to be broadly interpreted. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “or,” “and,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
receiving, by a processor, a query from a user device;
generating, by the processor, a query embedding representing the query;
identifying, by the processor, at least one question corresponding to the query by comparing the query embedding to a plurality of embeddings of prior questions; and
transmitting, by the processor, an answer corresponding to the at least one question to the user device in response to the query.

2. The method of claim 1, wherein comparing the query embedding to a plurality of embeddings of questions comprises determining distances between the query embedding and each of the plurality of embeddings.

3. The method of claim 1, further comprising generating a question-answer mapping and caching the question-answer mapping prior to receiving the query.

4. The method of claim 3, wherein generating a question-answer mapping comprises:
reading a question from a question bank;
identifying a plurality of candidate documents for a given question in the question;
inputting the plurality of candidate documents into a transformer model, the transformer model outputting one or more answers present in the plurality of candidate documents;
selecting a subset of the one or more answers as answers to the given question; and
storing the question and the subset of the one or more answers as a mapping for the question.

5. The method of claim 4, wherein identifying a plurality of candidate documents comprises performing a search on a document corpus using the question.

6. The method of claim 4, wherein the transformer model outputs a location of the answer within a given candidate document.

7. The method of claim 4, further comprising training the transformer model by loading a generic transformer model, annotating a knowledge base with questions and answers, and re-training the generic transformer model using the knowledge base.

8. A non-transitory computer-readable storage medium for tangibly storing computer program instructions capable of being executed by a computer processor, the computer program instructions defining steps of:
receiving a query from a user device;
generating a query embedding representing the query;
identifying at least one question corresponding to the query by comparing the query embedding to a plurality of embeddings of prior questions; and
transmitting an answer corresponding to the at least one question to the user device in response to the query.

9. The non-transitory computer-readable storage medium of claim 8, wherein comparing the query embedding to a plurality of embeddings of questions comprises determining distances between the query embedding and each of the plurality of embeddings.

10. The non-transitory computer-readable storage medium of claim 8, further comprising generating a question-answer mapping and caching the question-answer mapping prior to receiving the query.

11. The non-transitory computer-readable storage medium of claim 10, wherein generating a question-answer mapping comprises:
reading a question from a question bank;
identifying a plurality of candidate documents for a given question in the question;
inputting the plurality of candidate documents into a transformer model, the transformer model outputting one or more answers present in the plurality of candidate documents;
selecting a subset of the one or more answers as answers to the given question; and
storing the question and the subset of the one or more answers as a mapping for the question.

12. The non-transitory computer-readable storage medium of claim 11, wherein identifying a plurality of candidate documents comprises performing a search on a document corpus using the question.

13. The non-transitory computer-readable storage medium of claim 11, wherein the transformer model outputs a location of the answer within a given candidate document.

14. The non-transitory computer-readable storage medium of claim 11, further comprising training the transformer model by loading a generic transformer model, annotating a knowledge base with questions and answers, and re-training the generic transformer model using the knowledge base.

15. A device comprising:
a processor; and
a storage medium for tangibly storing thereon logic for execution by the processor, the logic comprising instructions for:
receiving, by the processor, a query from a user device;
generating, by the processor, a query embedding representing the query;
identifying, by the processor, at least one question corresponding to the query by comparing the query embedding to a plurality of embeddings of prior questions; and
transmitting, by the processor, an answer corresponding to the at least one question to the user device in response to the query.

16. The device of claim 15, wherein comparing the query embedding to a plurality of embeddings of questions comprises determining distances between the query embedding and each of the plurality of embeddings.

17. The device of claim 15, the logic further comprising logic for generating a question-answer mapping and caching the question-answer mapping prior to receiving the query.

18. The device of claim 17, wherein generating a question-answer mapping comprises:
reading a question from a question bank;
identifying a plurality of candidate documents for a given question in the question;
inputting the plurality of candidate documents into a transformer model, the transformer model outputting one or more answers present in the plurality of candidate documents;
selecting a subset of the one or more answers as answers to the given question; and
storing the question and the subset of the one or more answers as a mapping for the question.

19. The device of claim 18, wherein identifying a plurality of candidate documents comprises performing a search on a document corpus using the question.

20. The device of claim 18, wherein the transformer model outputs a location of the answer within a given candidate document.
